(19) United States
(12) Patent Application Publication
(10) Pub. No.: US 2023/0252427 A1
(43) Pub. Date: Aug. 10, 2023

(54) MANAGEMENT APPARATUS, MANAGEMENT SYSTEM, MANAGEMENT METHOD, AND RETURNABLE CONTAINER

(71) Applicant: TOYOTA JIDOSHA KABUSHIKI KAISHA, Toyota-shi (JP)

(72) Inventors: Makoto Matsushita, Ichinomiya-shi Aichi-ken (JP); Hiroe Fukui, Toyota-shi Aichi-ken (JP); Naoki Uenoyama, Kasugai-shi Aichi-ken (JP); Hikaru Gotoh, Nagoya-shi Aichi-ken (JP); Satoshi Komamine, Nagoya-shi Aichi-ken (JP); Takanori Sasano, Toyota-shi Aichi-ken (JP)

(73) Assignee: TOYOTA JIDOSHA KABUSHIKI KAISHA, Toyota-shi Aichi-ken (JP)

(21) Appl. No.: 18/106,800

(22) Filed: Feb. 7, 2023

(30) Foreign Application Priority Data
Feb. 9, 2022 (JP) 2022-019061

(51) Int. Cl. G06Q 10/20; G06Q 10/0837; G06Q 30/0207; G01N 21/90

(52) U.S. Cl. CPC G06Q 10/20; G06Q 10/0837; G06Q 30/0207; G01N 21/90

(57) ABSTRACT

A management apparatus includes a controller configured to plan maintenance of a returnable container based on information about a condition of the returnable container, the returnable container being configured to store a delivery item inside.

### CROSS-REFERENCE TO RELATED APPLICATION

This application claims priority to Japanese Patent Application No. 2022-19061, filed on Feb. 9, 2022, the entire contents of which are incorporated herein by reference.

### TECHNICAL FIELD

The present disclosure relates to a management apparatus, a management system, a management method, and a returnable container.

### BACKGROUND

Package delivery systems using delivery boxes are known. For example, see Patent Literature (PTL) 1.

### CITATION LIST

### Patent Literature

PTL 1: JP 2021-62968 A

### SUMMARY

When returnable containers are used to deliver items, efficient operation of the returnable containers is required.

It would be helpful to improve the operation efficiency of returnable containers.

A management apparatus according to an embodiment of the present disclosure includes a controller configured to plan maintenance of a returnable container based on information about a condition of the returnable container, the returnable container being configured to store a delivery item inside.

A management system according to an embodiment of the present disclosure includes the aforementioned management apparatus; a returnable container configured to store a delivery item inside; and a mobile object that delivers the returnable container.

A management method according to an embodiment of the present disclosure includes: planning maintenance of a returnable container based on information about a condition of the returnable container, the returnable container being configured to store a delivery item inside.

A returnable container according to an embodiment of the present disclosure is configured to store a delivery item. The returnable container includes a detector configured to detect a condition of the returnable container and a communication interface configured to output a result of detecting the condition of the returnable container.

According to the management apparatus, the management system, the management method, and the returnable container according to the embodiments of the present disclosure, the operation efficiency of returnable containers can be improved.

### BRIEF DESCRIPTION OF THE DRAWINGS

In the accompanying drawings:

FIG. 1 is a block diagram illustrating an example configuration of a management system according to an embodiment;

FIG. 2 is a schematic diagram illustrating an example configuration of a mobile object;

FIG. 3 is a schematic diagram illustrating an example configuration of a returnable container; and

FIG. 4 is a flowchart illustrating an example procedure of a management method according to an embodiment.

### DETAILED DESCRIPTION

### Example Configuration of Management System 1

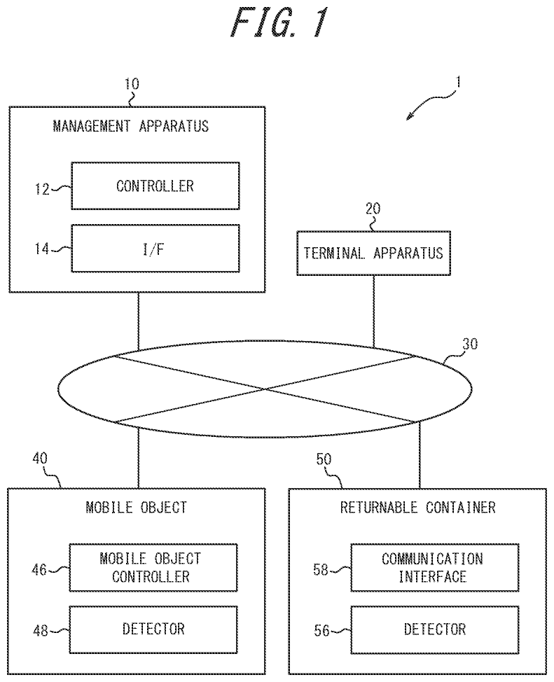

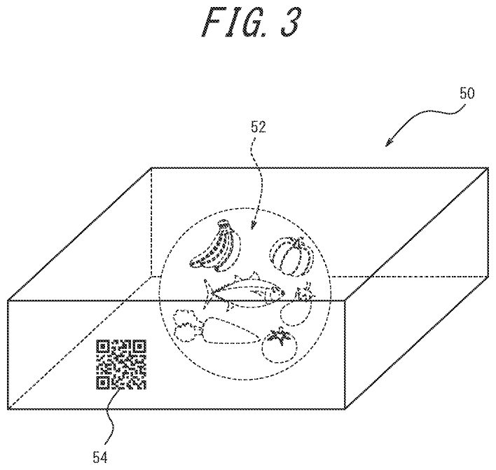

As illustrated in FIG. 1, a management system 1 according to an embodiment includes a management apparatus 10, a mobile object 40, and a returnable container 50. The management system 1 further includes a non-essential terminal apparatus 20. In the management system 1, the mobile object delivers delivery items 52 (see FIG. 3) that are stored in a returnable container 50. The management apparatus 10 manages the mobile object 40 and the returnable container 50. The management apparatus 10 may be divided into an apparatus for managing the mobile object 40 and an apparatus for managing the returnable container 50.

<Management Apparatus 10>

The management apparatus 10 includes a controller 12 and an interface 14. The interface 14 is also referred to as an I/F 14.

The controller 12 controls at least one component of the management apparatus 10. The controller 12 may be configured to include at least one processor. The “processor” is a general purpose processor, a dedicated processor specialized for specific processing, or the like in the present embodiment but is not limited to these. The controller 12 may be configured to include at least one dedicated circuit. The dedicated circuit may include, for example, a field-programmable gate array (FPGA) or an application specific integrated circuit (ASIC). The controller 12 may be configured with the dedicated circuit instead of the processor, or may be configured with the dedicated circuit along with the processor.

The management apparatus 10 may further include a memory. The memory is a semiconductor memory, a magnetic memory, an optical memory, or the like, for example, but is not limited to these. The memory may function, for example, as a main memory, an auxiliary memory, or a cache memory. The memory may include an electromagnetic storage medium, such as a magnetic disk. The memory may include a non-transitory computer readable medium. The memory stores any information used for operation of the management apparatus 10. For example, the memory may store a system program, an application program, or the like. The memory may be included in the controller 12.

Information, data, or the like is outputted from and inputted to the controller 12 through the I/F 14. The I/F 14 may include a communication module for communication with other devices, such as the mobile object 40 or the terminal apparatus 20, via a network 30. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The I/F 14 may be configured to be connected to the communication module.

The I/F 14 may be configured with an input device for receiving inputs, such as information or data, from a user. The input device may be configured with, for example, a touch panel, a touch sensor, or a pointing device such as a mouse. The input device may be configured with a physical key. The input device may be configured with an audio input device, such as a microphone.

The I/F 14 may be configured with an output device that outputs information, data, or the like to the user. The output device may include, for example, a display device that outputs visual information, such as images, letters, or graphics. The display device may be configured with, for example, a Liquid Crystal Display (LCD), an organic or inorganic Electro-Luminescent (EL) display, a Plasma Display Panel (PDP), or the like. The display device is not limited to the above displays and may be configured with various other types of displays. The display device may be configured with a light emitting device, such as a Light Emitting Diode (LED) or a Laser Diode (LD). The display device may be configured with various other devices. The output device may include, for example, an audio output device, such as a speaker, that outputs audio information, such as voice. The output device is not limited to the above examples and may include various other devices.

The management apparatus 10 may include a single server apparatus or a plurality of server apparatuses capable of communicating with each other.

<Mobile Object 40>

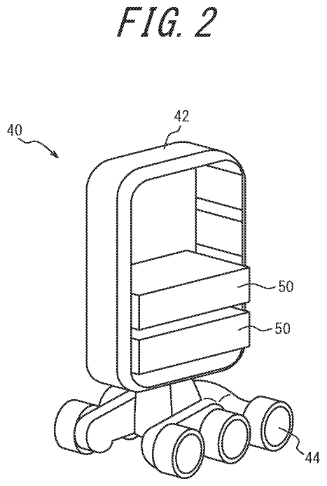

As illustrated in FIG. 2, the mobile object 40 includes a body 42, with a storage space for storing returnable containers 50, and a driver 44 for moving the mobile object 40.

The body 42 may be equipped with a locking mechanism configured to lock the returnable containers 50 stored in the storage space. The body 42 may be provided with a sensor to detect that a returnable container 50 has been stored.

The driver 44 may, for example, include wheels or caterpillars as a mechanism for traveling on a road surface. The driver 44 may further include a drive mechanism such as a motor or engine that drives the wheels, caterpillars, or the like. The driver 44 may further include components such as gears that transmit power from the drive mechanism to the wheels, caterpillars, or the like. The driver 44 may further include a battery to supply power or a tank to supply fuel to the drive mechanism.

As illustrated in FIG. 1, the mobile object 40 further includes a non-essential mobile object controller 46. The mobile object controller 46 controls at least one component of the mobile object 40, such as the body 42 or driver 44 of the mobile object 40. The mobile object controller 46 may acquire destination information specifying a destination from the management apparatus 10 and control the driver 44 to travel autonomously based on the destination information. The mobile object 40 may acquire control information indicating the timing at which to start or stop traveling, the travel speed, or the like from the management apparatus 10 and control the driver 44 to travel based on the control information. In a case in which the returnable container 50 is stored in the body 42, the mobile object controller 46 may output information identifying the stored returnable container 50 to the management apparatus 10. In a case in which the returnable container 50 is removed from the body 42, the mobile object controller 46 may output information identifying the removed returnable container 50 to the management apparatus 10. The mobile object controller 46 may measure, and output to the management apparatus 10, the time it takes for storage of the returnable container 50 or for unloading of the returnable container 50.

The mobile object controller 46 may be configured to include at least one processor. The mobile object controller 46 may be configured to include one or more dedicated circuits instead of the processor, or may be configured to include a dedicated circuit along with the processor. The mobile object 40 may be configured to include a memory. The memory of the mobile object 40 may be configured to be identical or similar to the memory of the management apparatus 10. The mobile object 40 may be configured to include an I/F or a communication module. The I/F or communication module of the mobile object may be configured to be identical or similar to the I/F or communication module of the management apparatus 10.

The mobile object 40 may be configured to include a positional information detector that acquires the positional information for the mobile object 40 itself. The mobile object 40 may output the positional information for the mobile object 40 itself to the management apparatus 10. The positional information detector may be configured to include a receiver compliant with a satellite positioning system. The receiver compliant with the satellite positioning system may include, for example, a Global Positioning System (GPS) receiver.

The number of mobile objects 40 managed by the management system 1 may be two or more. The mobile object 40 is not limited to the configuration illustrated in FIG. 2 but may be configured in a variety of other ways to store the returnable container 50 and move.

The mobile object 40 may further include a non-essential detector 48. The detector 48 detects changes caused by dirtiness or wetness, or by damage, deformation, or the like, of the returnable container 50 stored in the body 42. The detector 48 may, for example, be configured to include a camera that captures images of the exterior of the returnable container 50. The detector 48 may be configured to include a sensor that detects changes occurring in the returnable container 50 as various physical quantities. The detector 48 may be provided with a voltage sensor, resistance sensor, or the like that detects dirtiness or wetness in the returnable container 50 by the short circuiting of an electric wire. The detector 48 may be provided with a pressure sensor, a tactile sensor, or the like that detects an external force due to damage or deformation of the returnable container 50. The detector 48 may be provided with an optical sensor that optically detects damage or deformation of the returnable container 50. The mobile object controller 46 may determine the condition of the returnable container 50 based on the detection result from the detector 48 and output the result of determining the condition of the returnable container 50 to the management apparatus 10 as information about the condition of the returnable container 50. The mobile object controller 46 may output the actual detection result from the detector 48 to the management apparatus 10 as the information about the condition of the returnable container 50.

<Returnable Container 50>

As illustrated in FIG. 3, the returnable container 50 is configured to store delivery items 52 inside. The returnable container 50 is not limited to storing the illustrated food items and may be configured to store a variety of other items, such as daily necessities, miscellaneous items, or books as the delivery items 52. The number of returnable containers 50 included in the management system 1 is not limited to one and may be two or more.

The returnable container 50 includes a non-essential identifier 54. The identifier 54 may be located on the outside of the returnable container 50 and be configured to appear as part of the exterior of the returnable container 50. The identifier 54 may be configured as a two-dimensional code, for example, or as a bar code, or may contain letters or graphics. The identifier 54 may be configured to output information identifying an individual returnable container 50. The identifier 54 may output information identifying an individual returnable container 50 to the mobile object 40, the terminal apparatus 20, or the like via wireless communication. The identifier 54 is not limited to these examples and may be configured in a variety of ways that enable identification of individual returnable containers 50.

The returnable container 50 is further provided with a non-essential detector 56, as illustrated in FIG. 1. The detector 56 detects changes occurring in the returnable container 50 due to dirtiness or wetness, or due to damage, deformation, or the like. The detector 56 may be provided with a current sensor, resistance sensor, or the like that detects a crack in the returnable container 50 by the disconnection of an electric wire. The detector 56 may be provided with a voltage sensor, resistance sensor, or the like that detects dirtiness or wetness in the returnable container 50 by the short circuiting of an electric wire. In other words, the detector 56 may be provided with a sensor that electromagnetically detects abnormalities in the returnable container 50. These examples are not limiting, and the detector 56 may be provided with various other sensors. The detector 56 may output the result of determining the condition of the returnable container 50 itself based on the detection result.

The returnable container 50 is further provided with a non-essential communication interface 58, as illustrated in FIG. 1. The communication interface 58 may include a communication module for communication with other devices, such as the management apparatus 10, the mobile object 40, or the terminal apparatus 20, via the network 30. The communication interface 58 may output the detection result from the detector 56 to the management apparatus 10. The communication interface 58 may output information from the identifier 54 that identifies an individual returnable container 50 to the management apparatus 10.

<Terminal Apparatus 20>

The terminal apparatus 20 may accept input of information, from the user who ships the delivery item 52, specifying the place or time to ship the delivery item 52 and may output the inputted information to the management apparatus 10. The terminal apparatus 20 may accept input of information, from the user who receives the delivery item 52, specifying the place or time to receive the delivery item 52 and may output the inputted information to the management apparatus 10. The terminal apparatus 20 may acquire information about the delivery status of the delivery item 52 from the management apparatus 10 and notify the user who shipped the delivery item 52 or the user who is to receive the delivery item 52 of the delivery status of the delivery item 52.

The terminal apparatus 20 may be configured to include one or more processors or one or more dedicated circuits. The terminal apparatus 20 may be configured to include a memory. The memory of the terminal apparatus 20 may be configured to be identical or similar to the memory of the management apparatus 10. The terminal apparatus 20 may be configured to include an I/F or a communication module. The I/F or communication module of the terminal apparatus 20 may be configured to be identical or similar to the I/F or communication module of the management apparatus 10.

The terminal apparatus 20 may be configured to include an input device for receiving inputs, such as information or data, from the user. The input device may be configured to include the various devices described as the I/F 14. The terminal apparatus 20 may be configured to include an output device that outputs information, data, or the like to the user. The output device may be configured to include the various devices described as the I/F 14.

The terminal apparatus 20 may be configured to include a camera. The terminal apparatus 20 may output the images captured by the camera to the management apparatus 10.

The number of terminal apparatuses 20 included in the management system 1 is not limited to one and may be two or more. The terminal apparatus may be configured as a mobile terminal, such as a smartphone or a tablet, or a Personal Computer (PC), such as a notebook PC or a tablet PC. The terminal apparatuses 20 are not limited to the above examples and may include various devices.

### Operation Example of Management System 1

In the management system 1 according to the present embodiment, the management apparatus 10 manages the operation of each mobile object 40 in the plurality of mobile objects 40. The management apparatus 10 manages the operation of the mobile object 40 so that the mobile object 40 stores the delivery item 52 at the delivery source and delivers the delivery item 52 to the delivery destination. The delivery source includes the location from which the delivery item 52 is shipped. The delivery item 52 may be shipped from the user, such as a corporation or individual, or from a distribution center or the like that has collected the delivery item 52. The delivery destination includes the location at which the delivery item 52 is to be received. The delivery item 52 may be received by a user, such as a corporation or individual, or by a distribution center or the like that collects the delivery item 52. These examples are not limiting, and the delivery source or destination may include a variety of locations.

The management apparatus 10 also plans maintenance of the returnable container 50 based on information about the condition of the returnable container 50. An example of operations of the management apparatus 10 is described below.

<Acquisition of Information About Condition of Returnable Container 50>

The controller 12 of the management apparatus 10 acquires information about the condition of the returnable container 50. The controller 12 may acquire, as the information about the condition of the returnable container 50, information indicating whether the returnable container 50 is dirty or wet. The controller 12 may acquire, as the information about the condition of the returnable container 50, information indicating whether the returnable container 50 is damaged or deformed.

The controller 12 may acquire, as the information about the condition of the returnable container 50, an image of the exterior of the returnable container 50. An image of the exterior of the returnable container 50 may be captured by the camera of the detector 48 in the mobile object 40. An image of the exterior of the returnable container 50 may be captured by a camera of the terminal apparatus 20. An image of the exterior of the returnable container 50 may be captured by user operation or automatically. The information about the condition of the returnable container 50 may include information identifying an individual returnable container 50. The information identifying an individual returnable container 50 may include a captured image of the identifier 54 included on the exterior of the returnable container 50. The information identifying an individual returnable container 50 may include information received by the mobile object 40 or the terminal apparatus 20 from the identifier 54 via wireless communication.

The controller 12 detects the condition of the returnable container 50 based on the acquired image of the exterior of the returnable container 50. The controller 12 may detect the condition of the returnable container 50 by performing image recognition processing on the image of the exterior of the returnable container 50. The controller 12 may detect the condition of the returnable container 50 using a machine-learned model that outputs the result of determining the condition of the returnable container 50 when an image of the exterior of the returnable container 50 is inputted. When the returnable container 50 is used from the delivery source to the delivery destination, the controller 12 may detect changes in the condition of the returnable container 50 by comparing an image of the returnable container 50 captured at the delivery source with an image of the returnable container 50 captured at the delivery destination. Based on the image of the identifier 54 included in the image of the exterior of the returnable container 50, the controller 12 may associate information identifying the returnable container 50 with the result of detecting of the condition of the returnable container 50.

The controller 12 may acquire, as the information about the condition of the returnable container 50, the detection result from the detector 48 of the mobile object 40 or the detector 56 of the returnable container 50 and may detect the condition of the returnable container 50 based on the acquired detection result. The controller 12 may detect the condition of the returnable container 50 by acquiring the result of determining the condition of the returnable container 50 from the detector 48 of the mobile object 40 or the detector 56 of the returnable container 50. The detector 48 of the mobile object or the detector 56 of the returnable container 50 may output the information identifying the returnable container 50 and the detection result for that returnable container 50 in association with each other. The information identifying the returnable container 50 may include information based on the identifier 54.

In a case in which the returnable container 50 is damaged or deformed, the external shape of the returnable container 50 might no longer conform to the shape of the portion supporting the returnable container 50 in the housing space of the body 42 of the mobile object 40. As a result of the outer shape of the returnable container 50 not conforming to the shape of the portion supporting the returnable container 50, the returnable container 50 may catch on the inner walls of the housing space when the returnable container 50 is placed into or removed from the housing space. Consequently, it may take longer to load or unload the damaged or deformed returnable container 50 into and off the mobile object 40. The controller 12 may therefore acquire, from the mobile object 40, the time it takes to load or unload the returnable container 50 into and off the mobile object 40 and detect the condition of damage or deformation of the returnable container 50 based on the acquired time. The controller 12 may acquire, from the mobile object 40, the time it takes to load or unload the returnable container 50 into and off the mobile object 40. The controller 12 may accumulate actual data on the time it takes to load and unload the returnable container 50 into and off the mobile object 40 and detect the condition of damage or deformation of the returnable container 50 based on the actual data. The controller 12 may accumulate actual data on the time required to load and unload the returnable container 50 for each combination of a returnable container 50 and the mobile object 40 and detect the condition of damage or deformation of the returnable container 50 using a model constructed based on the actual data.

The controller 12 may acquire, as the information about the condition of the returnable container 50, information inputted to the terminal apparatus by a user who used the returnable container 50 and detect the condition of the returnable container 50 based on the acquired information. The terminal apparatus 20 may accept input of information noticed by the user who used the returnable container 50. The terminal apparatus 20 may, for example, accept input of information indicating that the user perceived the returnable container 50 as being dirty or wet. The terminal apparatus 20 may accept input of information indicating that the user found it difficult to load or unload the returnable container 50 into or off the mobile object 40, or that the user considered the returnable container 50 to be damaged or deformed.

The controller 12 may acquire, as the information about the condition of the returnable container 50, information about the communication with the communication interface 58 of the returnable container 50. In the case of a loss of communication with the communication interface 58 of the returnable container 50, the controller 12 may detect that the condition of that returnable container 50 is abnormal.

The terminal apparatus 20 may capture an image of the returnable container 50 in response to an instruction from the user who used the returnable container 50. The terminal apparatus 20 may output a captured image of the returnable container 50 to the management apparatus 10 as the information about the condition of the returnable container 50. The controller 12 may detect the condition of the returnable container 50 based on the captured image of the returnable container 50. The controller 12 may detect a crack, dent, or the like in the returnable container 50 as the condition of the returnable container 50. The controller 12 may detect the condition of the returnable container 50 by performing image recognition on the captured image of the returnable container 50. The controller 12 may input captured images of the returnable container 50 into a machine-learned model and detect the estimated result of the condition of the returnable container 50 outputted from the learned model as the condition of the returnable container 50.

The terminal apparatus 20 may accept input of an evaluation result of the returnable container 50 by the user who used the returnable container 50. The terminal apparatus 20 may output the evaluation result of the returnable container 50 by the user to the management apparatus 10 as the information about the condition of the returnable container 50. The controller 12 may detect that the returnable container 50 is in poor condition in a case in which the returnable container 50 is evaluated as being in a poor condition, such as being dirty or damaged.

<Determination of Condition of Returnable Container 50>

The controller 12 detects the condition of the returnable container 50, such as dirtiness or wetness, or damage or deformation, based on information about the condition of the returnable container 50. The controller 12 determines whether the condition of the returnable container 50 is poor based on the result of detecting the condition of the returnable container 50.

The controller 12 may determine that the condition of the returnable container 50 is poor in a case in which the returnable container 50 is dirty or wet enough to affect the delivery item 52. The controller 12 may determine that the condition of the returnable container 50 is poor in a case in which the returnable container 50 is deformed to the point of making storage in the mobile object 40 impossible or difficult. The controller 12 may determine that the condition of the returnable container 50 is poor in a case in which the returnable container 50 is damaged to the point that water, dust, or the like can enter inside. The controller 12 may determine that the condition of the returnable container 50 is poor in a case in which the returnable container 50 is shaped in such a way as to damage the mobile object 40 or another returnable container 50.

The controller 12 may acquire the result of determining the condition of the returnable container 50 from the detector 48 of the mobile object 40 or the detector 56 of the returnable container 50 and may determine whether the condition of the returnable container 50 is poor based on the acquired determination result. The controller 12 may determine whether changes have occurred in the returnable container 50 due to dirtiness or wetness, or damage or deformation, based on the detection result from the detector 48 of the mobile object 40 or the detector 56 of the returnable container 50. In other words, the controller 12 may determine whether the condition of the returnable container 50 is poor based on the detection result from the detector 48 of the mobile object 40 or the detector 56 of the returnable container 50. The controller 12 may determine whether the condition of the returnable container 50 is poor based on an image of the returnable container 50 captured by the terminal apparatus 20 or the camera in the detector 48 of the mobile object 40.

<Plan for Maintenance of Returnable Container>

The controller 12 plans maintenance of the returnable container 50 in a case in which the condition of the returnable container 50 is poor. The controller 12 may determine the content of the maintenance work to be performed on the returnable container 50 based on the information about the condition of the returnable container 50.

The controller 12 may, for example, determine to clean or dry the returnable container 50 as the maintenance work on the returnable container 50 in a case in which the returnable container 50 is dirty or wet. The controller 12 may determine to perform repair as the maintenance work on the returnable container 50 in a case in which the returnable container 50 is damaged or deformed.

In a case in which the controller 12 determines that the condition of the returnable container 50 is poor, the controller 12 may immediately issue an instruction to maintain the returnable container 50. In a case in which a delivery item 52 is stored in the returnable container 50 at the time when the controller 12 determines that the condition of the returnable container 50 is poor, the controller 12 may issue an instruction to maintain the returnable container 50 after completion of delivery of the delivery item 52. The controller 12 may issue an instruction so that the delivery item 52 that was stored in the returnable container 50 at the time when the condition of the returnable container 50 was determined to be poor is immediately transferred to another returnable container 50 that then continues delivery.

In a case in which the controller 12 determines that the condition of the returnable container 50 is beyond repair based on the information about the condition of the returnable container 50, the controller 12 may determine to replace the returnable container 50 with a new returnable container 50. In other words, the controller 12 may determine whether to maintain or exchange the returnable container 50 based on the information about the condition of the returnable container 50. In a case in which it is determined to exchange the returnable container 50 with a new returnable container 50, the controller 12 may issue an instruction so that a delivery item 52 stored in the returnable container 50 is immediately transferred to another returnable container 50 that then continues delivery.

The controller 12 may monitor changes in the condition of the returnable container 50 and estimate the timing at which the condition of the returnable container 50 will be poor. The controller 12 may plan maintenance of the returnable container 50 in advance based on the result of estimating the condition of the returnable container 50. The controller 12 may issue an instruction so that the returnable container 50 is supplied for delivery operations based on the plan for maintenance of the returnable container 50.

<Granting of Incentive>

The controller 12 may grant an incentive to the user who inputted information about the condition of the returnable container 50 to the terminal apparatus 20 or who captured an image of the returnable container 50 with the terminal apparatus 20. The incentive may, for example, include points that can be used for the delivery fee, points that can be used for other services, or the like. The incentive may, for example, include the right to priority delivery in the delivery service. The controller 12 may grant the incentive to the user by transmitting information regarding the incentive to the terminal apparatus 20 in the user's possession.

The user can also evaluate the returnable container 50 as being in good condition. The terminal apparatus 20 may accept information indicating that the user evaluated the returnable container 50 as being in good condition. In a case in which the returnable container 50 is evaluated as being in a good condition, the controller 12 may consider that the user who used the returnable container 50 prior to the user who made the positive evaluation handled the returnable container 50 properly. The user who used the returnable container 50 prior to the user who evaluated the returnable container 50 is also referred to as a prior user. The controller 12 may grant an incentive to the prior user.

The user of the returnable container 50 may notice the dirty or wet condition of the returnable container 50 and clean or dry the returnable container 50 himself. The user of the returnable container 50 may also notice the damaged or deformed condition of the returnable container 50 and repair the returnable container 50 himself. The controller 12 monitors changes in the condition of the returnable container 50 based on the information about the condition of the returnable container 50. In a case in which the condition of the returnable container 50 changes to good during monitoring, the controller 12 may determine that the user who was using the returnable container 50 at that time performed maintenance on the returnable container 50. The controller 12 may grant an incentive to the user determined to have performed maintenance on the returnable container 50.

### Example Procedure for Management Method

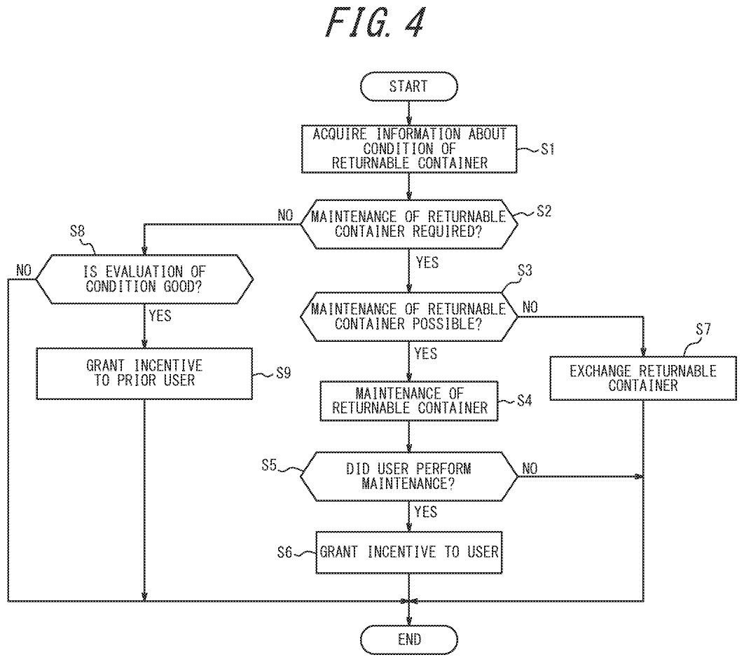

As described above, the controller 12 of the management apparatus 10 in the management system 1 according to the present embodiment plans maintenance of the returnable container 50 based on information about the condition of the returnable container 50. The controller 11 may, for example, perform a management method including the procedures of the flowchart illustrated in FIG. 4. The management method may be implemented as a management program to be executed by the controller 12.

The controller 12 acquires information about the condition of the returnable container 50 (step S1). The controller 12 determines whether maintenance of the returnable container 50 is required (step S2). In a case in which maintenance of the returnable container 50 is not required (step S2: NO), the controller 12 proceeds to the procedure of step S8, described below. In a case in which maintenance of the returnable container 50 is required (step S2: YES), the controller 12 determines whether maintenance of the returnable container 50 is possible (step S3). In other words, the controller 12 determines whether the returnable container 50 can be repaired for continued use or should be replaced.

In a case in which the controller 12 determines that maintenance of the returnable container 50 is possible (step S3: YES), the controller 12 determines the content of the maintenance work for the returnable container 50, and the maintenance is performed on the returnable container 50 (step S4). The controller 12 determines whether the user has performed the maintenance on the returnable container 50 (step S5). In a case in which the user has performed the maintenance on the returnable container 50 (step S5: YES), the controller 12 grants an incentive to the user (step S6). In a case in which the user has not performed the maintenance on the returnable container 50 (step S5: NO), the controller 12 terminates execution of the procedures in the flowchart of FIG. 4 without granting an incentive to the user.

In a case in which maintenance of the returnable container 50 is determined not to be possible (step S3: NO), the controller 12 exchanges the returnable container 50 with a new returnable container 50 (step S7). After performing the procedure of step S7, the controller 12 can end the execution of the procedures of the flowchart in FIG. 4.

Returning to the determination procedure of step S2, in a case in which maintenance of the returnable container 50 is not required (step S2: NO), the controller 12 determines whether the evaluation of the returnable container 50 is good (step S8). In a case in which the evaluation of the returnable container 50 is good (step S8: YES), the controller 12 grants an incentive to the prior user of the returnable container 50 (step S9). After performing the procedure of step S9, the controller 12 can end the execution of the procedures in the flowchart of FIG. 4. In a case in which the evaluation of the returnable container 50 is not good (step S8: NO), the controller 12 terminates execution of the procedures in the flowchart of FIG. 4 without granting an incentive to the user.

As described above, according to the management system 1, the management apparatus 10, and the management method of the present embodiment, maintenance of the returnable container 50 is planned based on information about the condition of the returnable container 50. In this way, returnable containers 50 in a poor condition are systematically maintained. As a result, the operation efficiency of the returnable containers 50 is increased.

While an embodiment of the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A management apparatus comprising a controller configured to plan maintenance of a returnable container based on information about a condition of the returnable container, the returnable container being configured to store a delivery item inside.

2. The management apparatus according to claim 1, wherein the controller is configured to detect a condition of dirtiness or wetness of the returnable container or a condition of damage or deformation of the returnable container based on the information about the condition of the returnable container.

3. The management apparatus according to claim 1, wherein the controller is configured to acquire, as the information about the condition of the returnable container, an image of an exterior of the returnable container.

4. The management apparatus according to claim 1, wherein the controller is configured to acquire, as the information about the condition of the returnable container, a result of detecting a change caused by a condition of dirtiness or wetness of the returnable container or a condition of damage or deformation of the returnable container.

5. The management apparatus according to claim 1, wherein the controller is configured to acquire, as the information about the condition of the returnable container, a time required to load and unload the returnable container onto and off a mobile object that delivers the returnable container.

6. The management apparatus according to claim 1, wherein the controller is configured to acquire, as the information about the condition of the returnable container, information inputted from a user who used the returnable container.

7. The management apparatus according to claim 6, wherein the controller is configured to grant an incentive to the user who inputted the information about the condition of the returnable container.

8. The management apparatus according to claim 6, wherein in a case in which the information inputted by the user who used the returnable container is information evaluating the condition of the returnable container as good, the controller is configured to grant an incentive to a prior user who used the returnable container before the user.

9. The management apparatus according to claim 1, wherein the controller is configured to determine a content of maintenance work to be performed on the returnable container based on the information about the condition of the returnable container.

10. The management apparatus according to claim 9, wherein the controller is configured to determine whether to maintain or replace the returnable container based on the information about the condition of the returnable container.

11. The management apparatus according to claim 1, wherein the controller is configured to grant an incentive to a user determined to have performed maintenance on the returnable container based on the information about the condition of the returnable container.

12. A management system comprising:
the management apparatus according to claim 1;
a returnable container configured to store a delivery item inside; and
a mobile object that delivers the returnable container.

13. A management method comprising: planning maintenance of a returnable container based on information about a condition of the returnable container, the returnable container being configured to store a delivery item inside.

14. The management method according to claim 13, further comprising detecting a condition of dirtiness or wetness of the returnable container or a condition of damage or deformation of the returnable container based on the information about the condition of the returnable container.

15. The management method according to claim 13, further comprising acquiring, as the information about the condition of the returnable container, an image of an exterior of the returnable container.

16. The management method according to claim 13, further comprising acquiring, as the information about the condition of the returnable container, a result of detecting a change caused by a condition of dirtiness or wetness of the returnable container or a condition of damage or deformation of the returnable container.

17. A returnable container configured to store a delivery item, the returnable container comprising:
a detector configured to detect a condition of the returnable container; and
a communication interface configured to output a result of detecting the condition of the returnable container.

18. The returnable container according to claim 17, further comprising an identifier that includes information identifying the returnable container.

19. The returnable container according to claim 17, wherein the detector is configured to include a sensor that electromagnetically detects the condition of the returnable container.

20. The returnable container according to claim 17, wherein the detector is configured to include a camera that captures an image of the returnable container.
